(19) United States
(12) Patent Application Publication
(10) Pub. No.: US 2025/0216309 A1
(43) Pub. Date: Jul. 3, 2025

(54) OPTICAL AEROSOL TRANSPORT SENSOR

(71) Applicants: Benjamin Alexander LaRiviere, Knoxville, TN (US); Milton Nance Ericson, Knoxville, TN (US); Paul W. Groth, Clinton, TN (US); Pooran Chandra Joshi, Blacksburg, VA (US)

(72) Inventors: Benjamin Alexander LaRiviere, Knoxville, TN (US); Milton Nance Ericson, Knoxville, TN (US); Paul W. Groth, Clinton, TN (US); Pooran Chandra Joshi, Blacksburg, VA (US)

(21) Appl. No.: 18/944,778

(22) Filed: Nov. 12, 2024

Related U.S. Application Data
(60) Provisional application No. 63/616,028, filed on Dec. 29, 2023.

(51) Int. Cl. G01N 15/0205; B29C 64/209; B29C 64/393; B33Y 30/00; B33Y 50/02

(52) U.S. Cl. CPC G01N 15/0211; B29C 64/209; B29C 64/393; B33Y 30/00; B33Y 50/02

(57) ABSTRACT

A system monitors properties of an aerosolized-ink stream that includes detectors and light sources configured to emit light of different wavelengths. The system includes a cell that includes flow axis that allows the aerosolized-ink stream to pass through the inner cavity formed in continuity with optical channels extending radially from the inner cavity along polar angles. The cell has an input positioned on a forward-scattering axis that coincides with an axis of one of the input light channels, with some forming azimuthal angles relative to a forward-scattering axis. A data acquisition module acquire scattering and/or absorption signals that are processed to identify relationships and/or against a model of multiple plurality of properties of the aerosolized-ink stream by a controller. The controller initiates corrective measures in response to the detected relationships and/or processed properties.

### 2. PRIORITY CLAIM

This application claims the benefit of priority from U.S. Provisional Application No. 63/616,028, filed Dec. 29, 2023, titled “Optical Aerosol Transport Sensor”, which is incorporated herein by reference in its entirety.

### 1. STATEMENT REGARDING FEDERALLY SPONSORED RESEARCH AND DEVELOPMENT

These inventions were made with United States government support under Contract No. DE-AC05-00OR22725 awarded by the United States Department of Energy. The United States government has certain rights in the inventions.

### 3. TECHNICAL FIELD

This disclosure relates to additive manufacturing, and specifically, to monitoring aerosol printing in real-time.

### 4. RELATED ART

Aerosol-Jet Printing (AJP) is an additive manufacturing process that creates objects by adding materials layer-by-layer. The successive layers may comprise metals, composites, and/or other materials.

Since the materials are to be added only where they are needed, inspections are often necessary to identify defects, misplacements, and misalignments. The deposits, resolutions, and forms of the desired objects, etc., are visually and/or electrically inspected after they are made. Adjustments that might prevent defects do not always occur as monitoring does not occur as they are made.

### DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views. The patent or application file also contains at least one drawing executed in color. Copies of this patent or patent application publication with color drawing(s) will be provided by the Office upon request and payment of the necessary fee.

FIG. 1 is an aerosol-jet printing system highlighting the aerosol generation, transport, and deposition processes.

FIG. 2 shows absorption and scattering cross-sections of a modeled silver ink showing the effect of the droplet distribution median diameter varied from two and ninety-one one hundredths micrometers to three and eleven hundredths micrometers.

FIG. 3 shows absorption and scattering cross-sections of a modeled silver ink showing the effect of varied water content for a fixed droplet size distribution.

FIG. 4 is a wireframe model of an optical scattering sensor, where the orange wireframed cylinder has optical properties of a water aerosol, and the blue line traces are ray traces for a collimated input light.

FIG. 5 is a graph showing scattered power detected as a function of the detector positions for two light sources with peak wavelengths of about four hundred and seventy nanometers and about eight hundred and ten nanometers.

FIG. 6 shows a decagon shell of an exemplary optical scattering sensor showing aerosol inlets and photodiodes that serve as detectors.

FIG. 7 is a cross-sectional view of the exemplary optical scattering sensor of FIG. 6.

FIG. 8 is a block diagram of an exemplary aerosol-jet printing system.

FIG. 9 shows the step changes of a transimpedance amplifiers due to changes in carrier gas flow rates varying between twenty cubic centimeters per minute, thirty five centimeters per minute, and zero centimeters per minute.

FIG. 10 shows calibrated responses of nine optical sensors to a varied carrier gas flow rate, with the top two panels showing the calibrated photodiode responses in log-scale, where the four hundred and seventy nanometer and eight hundred and ten nanometer responses are shown in blue and red tones, respectively, and the carrier gas flow rate is shown in linear scale in the bottom pane.

FIG. 11 shows calibrated responses of the optical sensor to varied ink compositions at a fixed carrier gas flow rate in which dilutions one and two comprise silver nanoparticle ink with water added at ratios of three to one and three to two ink-to-water ratios, respectively.

FIG. 12 shows a linear regression model prediction of absorption and scattering coefficients versus actual synthetic values for a test of eight-hundred simulated sensor responses to varied aerosol-jet printer aerosolized inks.

### DETAILED DESCRIPTION

An aerosol-jet printing system and method (referred to as aerosol-jet printing system or system) applies aerosolized particles onto target surfaces to generate objects including patterns and structures. The patterns and/or structures may form wiring (e.g., metallization), circuits, and devices, for example. In some systems, materials are atomized through pneumatic devices, ultrasonic modules, and/or atomization processes that breakdown the source materials into finer particles that are then aerosolized and conveyed through a carrier gas. The flow rates, pressures, and variables associated with the carrier gas may be controlled by a data acquisition system and controller that control carrier gas variables such as its speed and the volume of materials it carries to the target surface. In some systems, adjusting one or more gas flows allow the data acquisition system and controller to the control the location of deposits and deposition rates. A nozzle such as a deposition head directs the aerosolized materials onto the targeted area. Some nozzles render high resolutions by delivering finer streams of materials and others deliver faster deposition rates to the target area. In some systems, a focusing gas such as a sheath focusing gas also flows through the nozzle to the target area to provide more precision and render finer detail to the objects.

To ensure the accuracy, thickness, and/or continuity of printed objects, an optical scattering sensor (also referred to as an aerosol scattering cell or cell) 104 renders quantitative measurements and feedback to a data acquisition system 816 and a controller 818 that may control printing processes and initiate corrective measures. The optical scattering sensor 104 measures optical scattering characteristics of the aerosolized materials at a plurality of angular positions. In spherical coordinates, the angle may comprise a polar angle (θ) and/or an azimuthal angle (ψ). A polar angle comprises the angle between the z-axis and a line connecting the origin to a point (the vertex of the angle). The azimuthal angle is the angle between a projection of the point onto an x-y-plane and the positive x-axis. A ψ=0° means the vertex is aligned with the positive x-axis. A ψ=900 means the vertex is aligned with the positive y-axis. A ψ=1800 means the vertex is aligned with the negative x-axis. A ψ=2700 means the vertex is aligned with the negative y-axis.

Some optical scattering sensors 104 measure the aerosol using two or more silicon photodetectors 702 and two or more electromagnetic sources. The optical responses from those silicon photodetectors 702 are processed to estimate the optical scattering and/or absorption properties of the aerosol material being delivered to the target area. In some systems, the optical responses comprise measurements of the optical scattering characteristics of the aerosolized material immediately prior to its flow into a deposition head 106; in other systems, monitoring occurs after the aerosolized material flows out of the deposition head 106 and before the materials are deposited on the target area such as a substrate 108; in other systems, monitoring occurs within the deposition head 106 (unitary with it); and in other systems, monitoring occurs through a combination of optical scattering sensors 104 positioned within the deposition head 106, before the aerosolized material flows into the deposition head 106, and/or after the aerosolized material flows out of the deposition head 106. In some systems, the disclosed monitoring measures and/or infers the aerosol material's composition, density, and/or droplet size distribution.

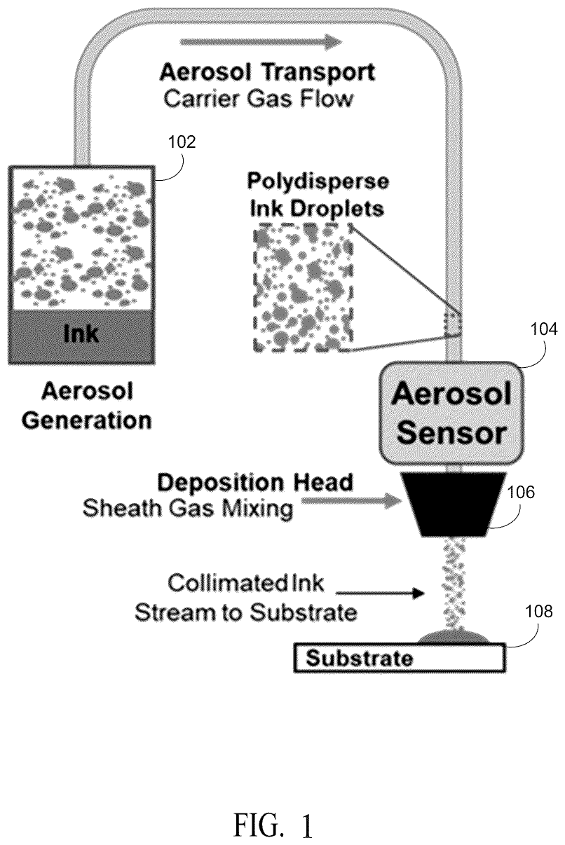

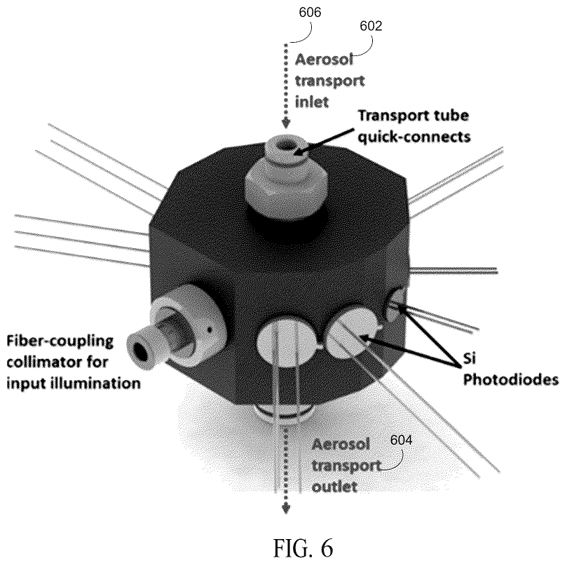

Some aerosol-jet printing systems generate a mist or spray from a liquid media 102 as shown in FIG. 1 through a pneumatic atomizer, ultrasonic atomizer (UA), or an atomization process. The droplet media is aerosolized and transported along a flow axis 606 to an inlet port 602 of an optical scattering sensor 104 by a carrier gas. In FIGS. 1 and 6, an outlet port 604 of the optical scattering sensor 104 feeds a deposition head 106 where the aerosolized media is aerodynamically focused and enveloped by a sheath focusing gas. The aerosolized media is deposited through flow onto an area of a targeted substrate 108 to form objects including electronically functional and/or mechanically functional patterns. In some systems the aerosolized media is deposited in a collimated laminar flow. In some systems, the resolution is as fine as about five to twenty micrometers (about 5-20 μm).

The optical scattering measurements of the aerosolized media immediately prior to deposition is predictive of the aerosol-jet printing deposition rates. The disclosed systems measures the coupling that occurs through the interaction of light with aerosolized particles or structures whose size is comparable to or smaller than the wavelength of light, specifically within the visible (VIS) and/or near-infrared (NIR) spectrum. In context, coupling refers to the interaction or resonance between light waves and the particles or structure they encounter, which in some systems is referred to as a Mie-type coupling. When light interacts with the particles that have dimensions on the scale of the wavelength of light, a resonance effect of the particles enhances the scattering and absorption rates, or localization of the light that is detected and measured by the optical scattering sensor 104.

In some systems, the composition of aerosolized materials, the aerosol's density, and the droplet size distributions, result in the measurement of variations in optical scattering and absorption rates within the visible (VIS) spectra and/or near-infrared (NIR) spectra. To discriminate between them, the optical scattering sensor 104 and monitoring system detect scattering at multiple scattering angles that form azimuthal angles relative to a flow path axis (e.g., a forward-scattering axis) and at multiple wavelengths, enabling the system to identify relationships, trends, and modeling by fitting and/or comparing measured scattering profiles to optical scattering and absorption properties measured or estimated through a data acquisition system (DAQ) 816 and a controller 818. At the controller 818, the measurements may be processed against models that may include machine learning models, linear regression models, etc., that detect and identify the optical scattering and absorption properties of the aerosolized particles. In some applications, the properties are mapped to known aerosol properties, including aerosol density, size distribution, and material composition, for example. In other applications, the relationship between the properties identify the characteristics of the aerosolized particles. In FIG. 1, the optical scattering sensor 104 shows one exemplary system measuring the optical scattering of the aerosolized particles immediately prior to the entry of the aerosolized media into the deposition head 106. The optical scattering sensor 104 enables the aerosol-jet printing system to measure changes to the media-stream composition occurring before the focusing and the deposition stages of the aerosol-jet printing system.

In some systems, the deposited layers must be continuous and free of pinholes to prevent the shorting between successive layers. This is especially important for thin layers such as submicron layers as the layers thickness contribute to the rendered object's resistance. Further, thinner layers generally have less mechanical strength. Surface flatness is as important as thickness in some systems. In some objects, deposits must be flat and as smooth as the disclosed layering system minimizes process steps, cracking, and substrate reflections. In some devices, deposited layers must be of uniform density. Varying densities within layers of the same media and thickness may yield different electrical and mechanical properties. This is because electrical current flow is affected as it passed through the media's interfaces. Mechanical properties also change with variable density areas. Further, stress free deposition is another requirement in some systems. Layers deposited under excess stress alleviate stress through cracking. Cracked deposits create roughness that may render electrical shorts to overlapping vertical layers, may cause open-circuit conditions along conductor lines, or may cracks may propagate resulting in delamination of deposited materials.

In some systems, the aerosol of aerosol-jet printing system comprises or consists of media droplets having about a one to five micrometers (about 1-5 μm) log-normal diameter distribution, with a median distribution near about three and one-tenth micrometers (about 3.1 μm). In these systems, the interaction of light with aerosolized droplet's coupling is measurable within the visible and/or near-infrared (NIR) spectra. The intensity of optical scattering and attenuation is expressed by scattering and absorption coefficients of the aerosol media. The coefficients comprise the probabilities of scattering and absorption events per a unit of distance of the optical path. For the aerosol-jet printing transport aerosolized droplets, the scattering and absorption probabilities of the aerosolized droplets may depend on cross-sections of the coupling that occurs through the interaction of light with aerosolized droplets or Mie cross-sections and the density of the droplets. As expressed in Equation 1, the optical coefficients of the aerosolized media comprises the sum of the product of a scattering cross-section, the wavelength of the light, and the number density of the droplets. The scattering coefficient, μₛ, for a wavelength λ may be expressed as

$${μ}_{s} ( λ ) = {\sum }_{d} {σ}_{s , d} ( λ ) {ρ}_{d} \qquad ( 1 )$$

for a distribution of discrete diameters d where σ_{s,d} comprises the scattering cross-section, ρ_{d} comprises the number density of droplets having a diameter d, and λ comprises the wavelength of light. Similarly, the absorption coefficient, μₐ, for a wavelength λ may be expressed as Equation 2

$${μ}_{a} ( λ ) = {\sum }_{d} {σ}_{a , d} ( λ ) {ρ}_{d} \qquad ( 2 )$$

where σ_{a,d} comprises the absorption cross section of a droplet having a diameter d.

The optical cross-sections of the droplets are derived from the optical scattering and absorption efficiencies scaled by the cross-sectional area of the droplets as expressed in Equation 3.

$${σ}_{s , d} ( λ ) = π / 4 {d}^{2} {Q}_{SCA} ( λ , d , m ( λ ) ) \qquad ( 3 )$$

Here, Q_{SCA}(λ, d, m(λ)) comprises the scattering efficiency of a single droplet, which is a function of the wavelength of light A, and the complex refractive index of the media m(λ). The system calculates Q_{SCA} numerically, reflecting unpolarized light, that in some applications may be executed by an open-source Python module or Python software library or package by the controller 818. Recognizing that the complex refractive index comprises a material property of the liquid droplet, its estimation provides a measurement of the media or aerosolized composition, (e.g., solid fraction and/or solvent content). Analogous expressions for the absorption cross-section and absorption efficiency, Q_{ABS}, may depend on the droplet diameter and the complex refractive index in other applications.

In addition to the wavelength and droplet-size-dependent scattering and absorption probabilities, the angular direction of scattering may be calculated. The system calculates the effects of droplet size and material composition by applying a Henyey-Greenstein phase function as expressed by Equation 4

$$P ( cos {θ}_{s} ) = \frac{1 - {g}^{2}}{{( 1 + {g}^{2} - 2 g cos {θ}_{s} )}^{3 / 2}} \qquad ( 4 )$$

where P(cos θₛ) comprise the probability density function that describes the distribution of scattering angles; θₛ comprises the scattering angle, which is the angle between the incoming and scattered light direction; and g comprises the anisotropy parameter, which ranges from −1 to 1. The anisotropy parameter g defines how strongly light scatters to the forward and to the backward direction. If the anisotropy parameter, g, approaches one, the scattering continues in its original direction (a forward direction). When the anisotropy parameter, g, approaches minus one, the light is reflecting backward (a backward direction). When the anisotropy parameter, g, approaches 0, the light scatter nearly equally in all directions (it is isotropic).

By simulating a large number of light rays, each simulated ray's interaction with the deposition media, such as its reflections, refractions, and scattering, is derived using probabilistic models that include the scattering coefficient, μₛ, the absorption coefficient, μₐ, and the anisotropy parameter, g. In some systems, the scattering characteristics of the aerosolized media is modeled using a Monte Carlo-based ray-tracing method with the scattering coefficient, μₛ, the absorption coefficient, μₐ, and the anisotropy parameter, g. Using an optical modeling and design software, such as Ansys Zemax OpticStudio software available form Ansys, Inc.®, for example, some systems estimate the optical coefficients that describe the optical scattering of the aerosolized media. In these systems, the complex refractive index of the media or liquid, m(λ), the aerosolized media droplet radius distribution, d, the number density of droplets as a function of diameter number density of droplets as a function of diameter, ρ_{d}, establish the optical coefficients that identify the optical scattering of the aerosolized media that may be correlated to known model parameter values.

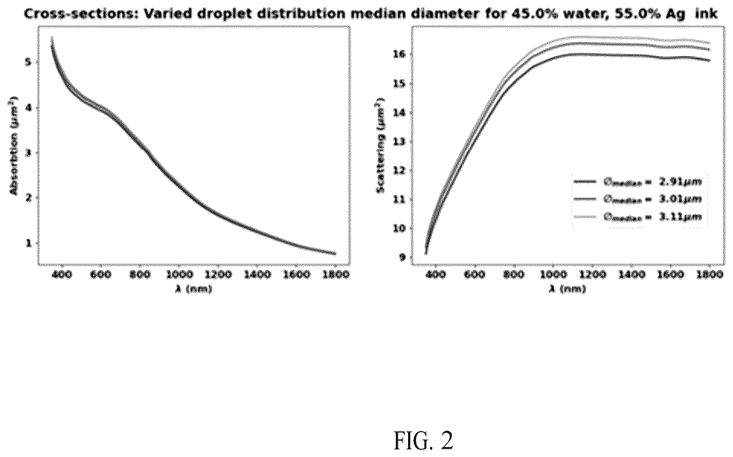

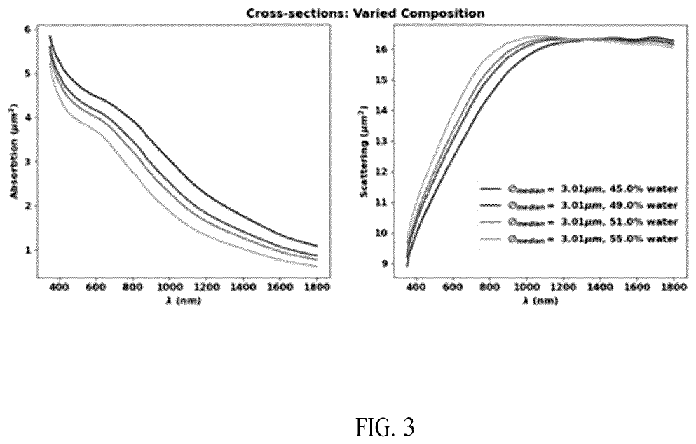

To establish the relationship between aerosolized characteristics such as median droplet diameter and media composition on optical properties, and to validate the optical scattering sensor for monitoring such properties, wavelength-dependent Mie scattering and absorption cross-sections were modeled. Optical properties of a model aerosol-jet printing media, such as an aerosol-jet printing ink, such as a media that includes silver (Ag) and water (H₂O), for example, were calculated using complex refractive indices for water and silver and a linear mixing rule. The purpose of the modeling was to obtain qualitative and representative estimates of the conductive media's (e.g., ink) aerosol optical properties. FIGS. 2 and 3 shows Mie scattering coefficients calculated for about a three hundred and fifty and one-thousand nanometer wavelength range for several silver-water droplet diameter distributions and compositions, where the droplet diameters for the ink aerosol followed a log-normal distribution.

In FIG. 2 the effect of the droplet distribution median diameter varied from about two and ninety one hundredths micrometers (about 2.91 μm) to about three and eleven hundredths micrometers (about 3.11 μm). The scattering and absorption cross-sections both increased with an increasing median droplet diameter, although the effect on scattering was more pronounced. The effect results in increased scattering of light by the aerosol, especially for wavelengths longer than about seven-hundred and fifty nanometers (about 750 nm). In FIG. 3, the effect of varied water content in the model aqueous ink is shown for a fixed droplet size distribution. The percentage of water in the model aqueous ink varied from about forty-five percent to about fifty percent (about 45% to 55%). The range shows that compositional variation has an influence on scattering and absorption cross-sections, with increased water content resulting in a lower absorption across the wavelength spectrum. However, the scattering profiles show an inflection point around about one-thousand and two hundred and fifty nanometers (about 1250 nm), where the increasing water content results in a decreased scattering of longer wavelengths of light and increased scattering for shorter wavelengths of light.

FIGS. 2 and 3 highlight the sensitivity of optical scattering and absorption to aerosol composition and droplet distribution. As expressed in Equations 1-3, the strength of scattering and absorption occurs because of a combination of the scattering and absorption cross-sections and the number density of the droplets. Spatial variation is achieved through optical measurements and scattering measurements at multiple angular positions relative to a light source. Spectral variation is achieved by multiplexing multiple light sources (e.g., generated by two or more light emitting diodes or a lone source that multiplex two or more separate and distinct wavelength emissions at a time) that have distinct wavelength emissions that may include the visible spectrum (VIS), the near-infrared (NIR) spectrum, or a combination of spectra.

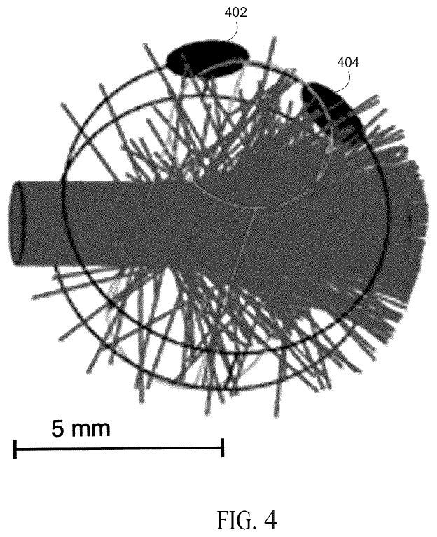

An exemplary optical scattering sensor comprises a silicon photodiode light collection and visible spectrum (VIS) LED light generation. While the near-infrared (NIR) spectrum provides insightful features and enhanced scattering of aerosols with a range of about one to a five micrometer range (e.g., about 1-5 μm) diameter distribution in some aerosol-jet printing systems, the higher responsivity in Amperes per Watt (A/W) of commercial silicon photodiodes compensates for the generally reduced scattering efficiency and enables low-level light collection without bulky and expensive cooled photodetection in some alternative exemplary optical scattering sensors. Direct collection of scattered light by photodiodes, rather than collection via waveguides (fibers) that are used in some alternate systems, further enhance photo collection, based on the larger physical input apertures as well as the many apertures afforded by photodiodes. The input aperture optically couples the light to a centrally located sensing cavity. The exemplary optical scattering sensor geometry is modeled to a small volume of water aerosols having varied droplet sizes. A representative modeled ray trace of optical properties is shown in FIG. 4.

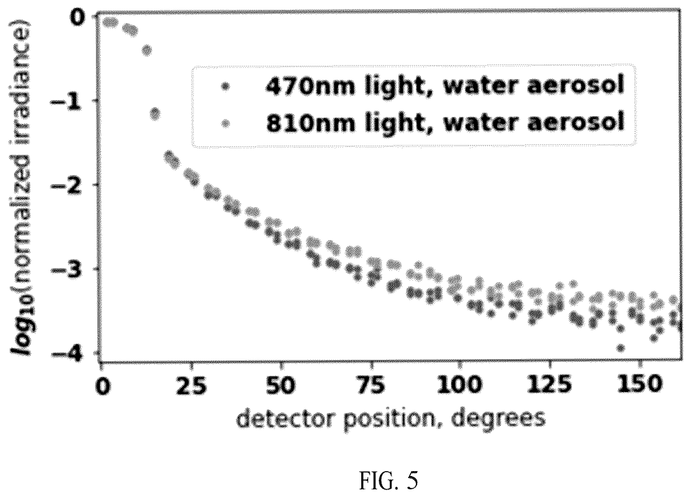

FIGS. 4 and 5 comprise a wireframe model of the exemplary optical scattering sensor and the scattered power function with respect to the detector positions, respectively. In FIG. 5, the intensity of the scattered light decrease exponentially as a function of the scattering angle. A pixelated cylindrical detector determined the minimum detector apertures that provided sufficient signal collection by integrating portions of the irradiance-vs-angle for a varied solid angle. The configuration, which includes the black discs that represent the collection apertures 402 and 404 in FIG. 4 that estimate the light collected at a given aperture size, was validated by comparing the integrated cylindrical detector quantities against those of the modeled radial detectors at various locations. To compensate for a higher intensity of the scattered light at angles closer to about zero degrees (about 0°), smaller collection apertures and photodiodes were used for collection at angles closer to about one-hundred and eighty degrees (about 180°). A larger collection aperture was used for about the zero degree (about 0°) transmission location to trap un-scattered light. Based on the integration of the modeled scattering profiles, apertures of about one millimeter diameter (about 1 mm diameter) for lower angles, and about two millimeter diameter (about 2 mm diameter) for higher angles provided a measurable range of optical properties for more common aerosol-jet printing media (e.g., inks).

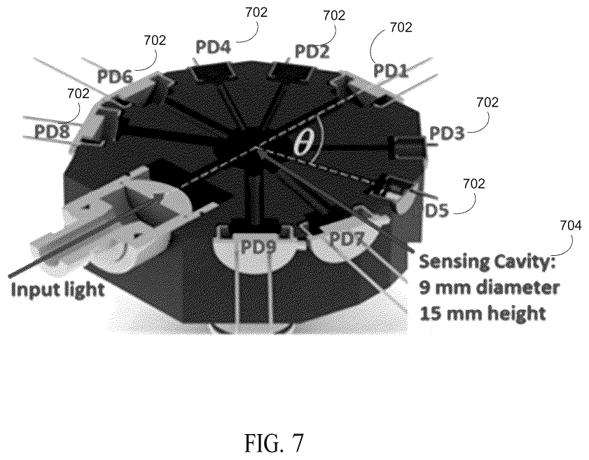

A second exemplary optical scattering sensor 104 is shown in FIGS. 6 and 7, respectively. As shown, multiple silicon photodiode detectors 702 (e.g., three or more or N detectors) are positioned within the decagon-shaped optical scattering sensor body. Nine are shown (e.g., N=9 or PD1-PD9) in FIG. 7. An optical fiber couples a collimator 808 that narrows a beam of light waves by forming parallel light beams that ensures that the electromagnetic rays travel in straight or substantially straight lines. The optical fiber aligns one or more light sources that emits light of different wavelengths λᵢ, where i is greater than 1 (e.g., i≥2) to an input aperture. An inlet port 602 in fluid communication for aerosol flow with an outlet port 604 (shown in FIG. 6) along a flow axis 606 allows an aerosolized media to pass through the sensing cavity 704 of the exemplary optical scattering sensor.

Multiple optical channels extend radially from the sensing cavity of the exemplary optical scattering sensor terminating at one of the multiple silicon photodiodes 702. The number N of optical channels pass along polar angles θⱼ relative to the flow axis, where the number of polar angles, j, is equal to or less than the number of optical channels, N. In some optical scattering sensors 104, the polar angles θⱼ comprise right angles, such that the silicon photodiode detectors 702 are disposed within an orthogonal plane to the flow axis 606.

With respect to FIGS. 6 and 7, the input aperture through which lights is optically coupled to the sensing cavity 704 of the second exemplary optical scattering sensor 104 is positioned on a forward scattering axis that coincides with the axis of one of the optical channels, with the remaining optical channels forming respective azimuthal angles ψₖ relative to the forward scattering axis. In some exemplary optical scattering sensors 104, the number of azimuthal angles is less than or equal to one less the number of optical channels N (e.g., k≤(N−1)).

A physical embodiment of an exemplary optical scattering sensor may be machined from black polyacetal plastic (e.g., an acetal homopolymer such as Delrin produced by Dupont®) and formed with apertures that receive photodiodes 702, optical windows, and threaded gas inlet 602 and outlet ports 604 that are compatible with aerosol fittings. The centrally positioned sensing cavity 704 comprises a cylinder of about nine millimeters (e.g., about 9 mm) in diameter and about fifteen millimeters (e.g., about 15 mm) in height. The top and bottom of the sensing cavity are threaded for 1/8-27 National Pipe Straight Mechanical (NPSM) quick-connections that facilitate connection to aerosol-jet printing system media transport lines. Silicon photodiode detectors 702 are separated from the aerosol media (e.g., the ink-stream aerosol) using about a five millimeter (e.g., about 5 mm) diameter sapphire windows with recesses, allowing press-fit sealing of the optical windows. The optical windows are set back from the sensing cavity 704 by cylindrical apertures that are about one centimeter (e.g., about 1 cm) long and about one to two millimeters (e.g., about 1 mm or 2 mm) in diameter. Exemplary silicon photodiodes 702, angular positions, aperture diameters, and their respective part numbers are shown in Table 1. The photodiode part numbers refers to parts manufactured by Thorlabs® an optical equipment company that manufactures photonic equipment.

TABLE 1
Photodiodes, Aperture, and Part Numbers

| PD# | Angle (degrees) | Aperture Diameter in mm | Part # |
|---|---|---|---|
| 0 | n/a (Ref Arm) | n/a | FDS1010 |
| 1 | 0 (Through) | 2 | FD100 |
| 2 | 30 | 1 | FD11A |
| 3 | 45 | 1 | FD11A |
| 4 | 60 | 1 | FD11A |
| 5 | 75 | 1 | FDS11A |
| 6 | 90 | 2 | FDS100 |
| 7 | 105 | 2 | FDS100 |
| 8 | 120 | 2 | FDS100 |
| 9 | 135 | 2 | FDS100 |

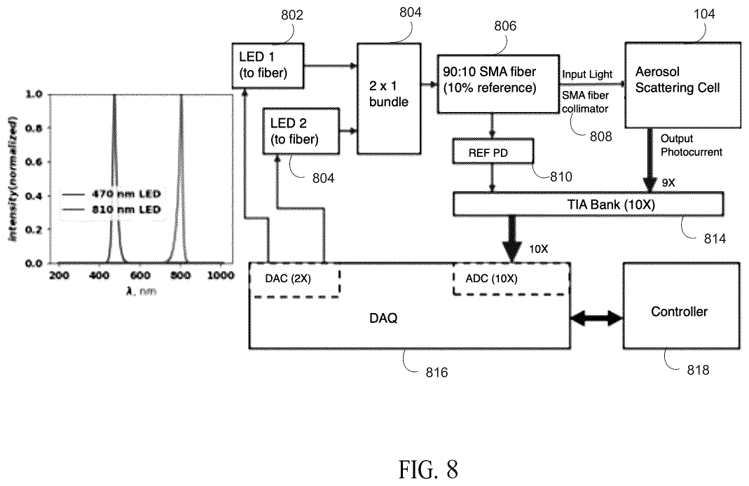

FIG. 8 is a block diagram of an exemplary aerosol-jet printing system. The system includes an exemplary optical scattering sensor 104 that is part of or comprises the aerosol scatter cell. The optical scattering sensor 104 acquires, concurrently from its silicon photodiode detectors 702, respective scattering signals, wherein each signal is generated by light having a different wavelength λᵢ where i is greater than 1 (e.g., i≥2) scattered along a respective angular direction by droplets of an aerosolized media, such as an aerosolized-ink stream, for example, as it passes through the sensing cavity 704.

Two or more electroluminescent light sources (e.g., an array of n electroluminescent light sources) 802 and 804 enable the exemplary optical scattering sensor 104 to differentiate between the scattering and absorption characteristics of an aerosol-jet printing media. An n-to-1 multiplexer 804 combines n channels of electroluminescent light into a single optical channel via an optical fiber. In FIG. 8, a Sub-Miniature version A (SMA) with a power splitting ratio module 806 divides the optical signal between two optical fiber pathways, unevenly. The ninety-ten (e.g., 90:10) fiber 806 feeds most of the optical signal (e.g., about ninety percent) to a Sub-Miniature version A (SMA) collimator 808 and feeds the remainder (about ten percent) to a reference detector 810 comprising a photodiode (PD). The output of the photodiode (PD) tracks the intensity of the optical signal. The output is also further processed by the controller 818 via the digital acquisition device 816 to compensate for fluctuations in the light intensity from the electroluminescent light sources 802 and 804.

The Sub-Miniature Version A collimator 808 narrows the majority of light waves received from the splitter into a collimated light beam. The collimated light beam is then focused and directed through a linear optical path into the optical scattering sensor 104. The output of the reference detector 810 and electrical outputs of the optical scattering sensor 104 feeds a collection or array of transimpedance amplifiers 814 operating in tandem that convert the current signals generated by the photodiodes of the reference detector 810 and the optical scattering sensor 104 into voltage signals. A data acquisition system (DAQ) 816 and controller 818 directs and controls the n electroluminescent light sources 802 and 804, ensuring that only one light source is active or radiating at a time at a certain intensity and fluctuation level via digital-to-analog converters (DAC). The n electroluminescent light sources 802 are controlled through transistor-transistor logic that compensates for the fluctuations in light intensity of the light sources by adjusting the gain and resolution of each over time in response to the fluctuations detected by the reference detector 810. The data acquisition system (DAQ) 816 also receives the voltage signals generated from the optical scattering sensor 812 via the transimpedance amplifiers 814.

In FIG. 8, the controller (also referred to as a controller module) 818 interfaces data acquisition system (DAQ) 816. In some aerosol-jet printing systems, the controller 818 monitors operations and performs tasks that detect changes in scattering and/or absorption characteristics of the aerosolized media. These characteristics may depend on cross-sections of the coupling that occurs through the interaction of light with aerosolized droplets or Mie cross-sections that rely on a scattering coefficients, Us, absorption coefficients, Ma, and anisotropy parameters, g, for example. Some controllers 818 detect changes in the properties of the aerosolized media and correlate those detections to known properties of aerosolized media to identify changes that may affect a desired specification such as an object's mechanical and/or electrical operation, for example. During printing, the controller 818 may process characteristics of multiple aerosol particles and measure scattering and absorptions characteristics, to detect aerosolized media properties and/or states in real-time.

Some controller 818 operations detect changes in aerosol media, without fitting scattering and/or absorption measurements to known optical properties of aerosolized media. The properties may be based on the relationships between parameters expressed in Equations 1-3. For example, an increase in a scattering coefficient, μₛ, relative to a model with a much slower increase in absorption coefficient, μₐ, may indicate an upward shift in an exemplary media droplet diameter distribution. Similarly, a decrease in a scattering coefficient, μₛ, along with an increase in an absorption coefficient, μₐ, may indicate a decrease in solvent content. Proportional increases to one another in a scattering coefficient, μₛ, and an absorption coefficient, μₐ, may indicate a shift in the number density. Whether by models such a linear regression models, relationships, machine learning models such as support vector machines, convolutional neural networks, decision trees, and/or passive machines or regenerative machines, networks, and algorithms, or other monitoring processes, the controller 818 may initiate and/or execute corrective actions in real-time as deviations occur or lie outside of a desired or predefined process window. Exemplary corrective actions may initiate automatic droplet size corrections to prevent or mitigate overspray or under-depositions, for example. Exemplary corrective actions may include adjustments to gas/aerosol pressure and/or flow rates to ensure the uniform deposition of the aerosolized media. Exemplary corrective actions may include print/deposition head adjustments to maintain the accuracy of printed the features. Exemplary corrective actions may include adjustments to the viscosity of the aerosolized media (e.g., aerosolized ink) to ensure consistent printing and prevent inconsistent depositions caused by changes in aerosolized media property. Exemplary corrective actions may include any combination of the disclosed exemplary corrective actions described herein and/or the other corrective actions that may allow the rendered object to meet or exceed mechanical specifications, electrical specifications, and/or other requirements. The terms “real-time” and “real time” are intended to broadly encompass systems that process events and/or data at the same rate the systems detect events or receive data, enabling the systems to detect signs of deterioration or abnormal operation but may have not failed and/or execute preventative measures like an automatic pilot automatically without manual intervention to prevent them or mitigate a malfunction.

To assess the ability of an exemplary aerosol-jet printing system's capability to monitor changes in aerosols transported from an atomizer to the aerosol-jet printing's deposition head 106 testing was performed on a media (e.g., ink) that comprises a silver (Ag) ink diluted with deionized (DI) water (the primary solvent for this ink), and pure deionized water. An ultrasonic atomizer (UA) generated the aerosol.

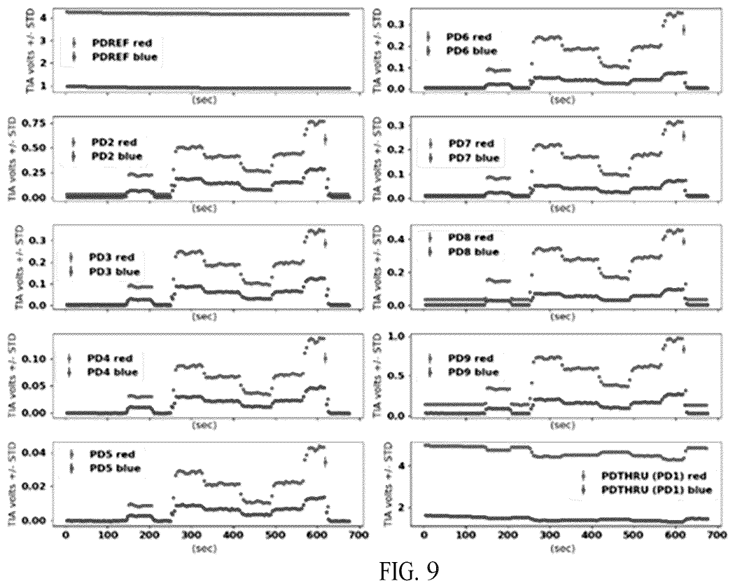

The refractive index of deionized water is well characterized, and the material composition of the water-as-ink is not sensitive to the effects of solvent evaporation, which facilitates comparison with optical modeling of the optical scattering sensor 104. The evaluation determined if each detector channel within the optical scatter sensor 104 had sufficient collection efficiency to respond to known changes in the transport aerosol and whether the magnitude of the response for each channel was what was expected based on optical modeling. The ability of each detector channel to respond to changes in the ink aerosol was tested by varying the carrier gas flow rate (CGFR), the ultrasonic atomizer (UA) current/voltage (e.g., resulting in an adjustment the power output of the atomizer), and ink composition in an ultrasonic atomizer (UA) cartridge. These changes may cause the atomizer to generate finer droplets, result in more liquid being converted into an aerosol form increasing throughput, an impact how efficiently the frequency of the ultrasonic transducer is maintained. FIG. 9 shows the uncalibrated response of the optical scattering sensor 104 for the water-based ink, where for each point in time, the measurements are the mean of twenty analog to digital converter (ADC) measurements of the transimpedance amplifier (TIA) 814 voltage outputs, with the standard deviation of the twenty measurements plotted as error bars. The step changes in photodiode detectors 702 are due to step-changes in the carrier gas flow rate (CGFR) varying between twenty cubic centimeters per minute, thirty five centimeters per minute, and zero centimeters per minute when the response is near zero. The standard deviation for the scattering detector measurements ranged between five tenths of a percent (0.5%) and two percent (2.0%) of the measurement magnitude for the time points at which the varying the carrier gas flow rate aerosol was present.

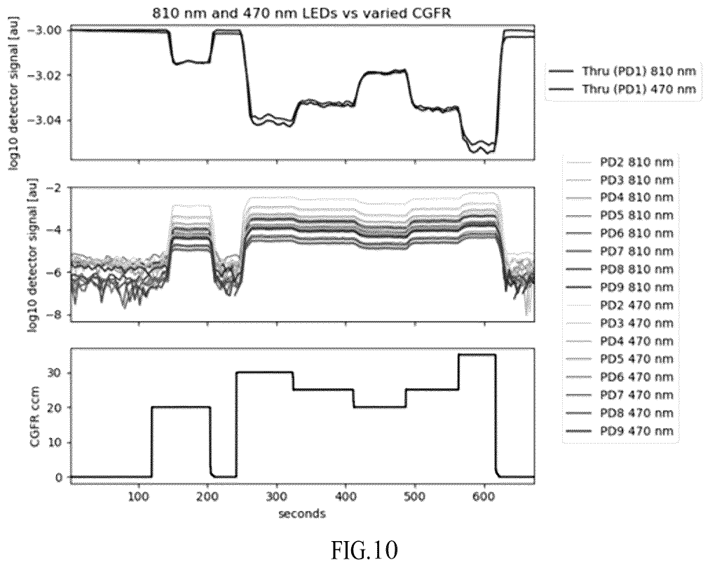

To establish that the photodiode detector 702 readings were close to the expected response for the optical sensor's geometry, calibration measurements were performed of the cell response to incident light along the axis of aerosol transport, e.g., orthogonal to the illumination direction shown in FIG. 7. Because of the multiple scattering of light by the aerosol in the sensing cavity 704, light entering the cell 104 along the aerosol transport axis 606 scatters isotropically along the axis of the array of the detector apertures. Therefore, the measurement of such light can be used to establish the ratios of the response magnitudes between detector channels. This calibration measurement accounts for differences in detector reading owing to factors including photodiode responsivity, optical window transmission efficiency, and collection efficiency of each detector aperture, e.g., owing to geometry and fabrication variations. The measurement was performed by removing the aerosol transport tube from the aerosol outlet quick-connect, inserting the input illumination fiber into the port, and flowing aerosolized deionized (DI) water into the sensing cavity. Specular reflections were removed by subtracting the measurements with zero flow for this configuration. To mitigate the dependence of the measurement on the launch condition of the input illumination in this configuration, e.g., owing to a precise alignment, a high-density water aerosol was generated with an ultrasonic (UA) atomizer current of about four-tenth milliamps (0.4 mA) at a varying the carrier gas flow rate (CGFR) of about sixty two cubic centimeters per minute (e.g., about 62 ccm). In this configuration, the light incident along the axis of the aerosol flow is scattered immediately after its entry into the sensing cavity 704, and the relative intensities measured at each detector port are weakly dependent on the precise alignment of the input illumination. To verify the calibration, the process was repeated multiple times with varied input fiber positioning, with negligible differences in the resulting calibration profiles. The optical scatter sensors responses are shown in FIG. 9 by these calibration measurements, as well as by the normalized reference photodiode (PD) readings, provided the normalized measurements shown in FIG. 10 which enables comparison with the modeled results.

The profiles in FIG. 10 were plotted along with the carrier gas flow rate (CGFR) recorded by the system's controller 818 (also referred to as the system's mass flow controller or MFC). The result revealed an expected correspondence between detector magnitude changes and the carrier gas flow rate (CGFR) setting. The delay between the detector response and the rising edge of the carrier gas flow rate and the controller readings, most notably for the first setpoint, is likely due to saturation of the transport tube surfaces by aerosolized ink which deposits on and/or is absorbed by the transport tube material—a process sometimes referred to by operators of aerosol-jet printing type systems as “seasoning” of the initially dry transport tubes.

The profiles generally show an exponential decrease in detector collection efficiency as the angle from the normal increased from about thirty degrees (about) 30° to one-hundred and thirty-five degrees to 135° for eight of the detectors (photodiodes 2-9; PD2 to PD9) (the angle was increased in fifteen degree increments). However, for the two detectors at angles greater than about one-hundred degrees (100°) (photodiodes 7 to 9; PD7 to PD9), the higher-angle detectors exhibited a slightly increased calibrated signal magnitude based on the modeling shown in FIG. 3.

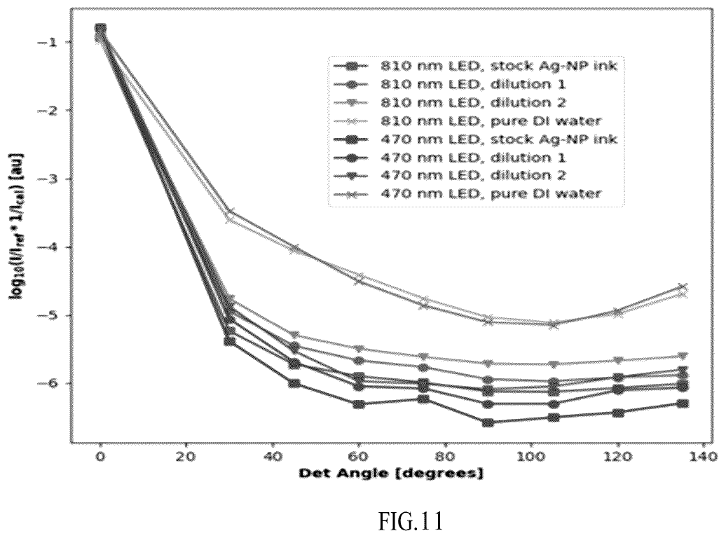

The calibrated responses for a silver nanoparticle ink (Ag—NP ink) is shown in FIG. 11. The silver nanoparticle ink was diluted at an ink-to-water ratio of about three-to-one (about a 3:1 identified as dilution 1), the same silver nanoparticle ink diluted at an ink-to-water ratio of about three-to-two (about 3:2 identified as dilution 2), and pure deionized (DI) water. Despite an increase in a higher angle scattering, the expected relationships between the silver nanoparticle ink composition, optical scattering wavelength, and measured sensor response, based on optical cross-section calculations, such as those shown in FIG. 2, are supported by the results shown in FIG. 11. In FIG. 11, a higher scattering signal is shown for aerosols with a higher water content, along with a higher scattering signal for about eight-hundred and ten (about 810 nm) electroluminescent light sources (here, LEDs) compared to the four hundred and seventy nanometer (about 470 nm) electroluminescent light sources.

To test whether an exemplary optical scattering sensor 104, based on ten detector 702 and two separate wavelength bands, is sufficient for differentiating between scattering and absorption changes, a synthetic dataset was generated with an absorption coefficient, μₐ, varying from approximately zero to nine-hundreds per millimeter (about 0 to 0.09 mm⁻¹), and a scattering coefficient, μₛ, ranging from about one-thousandths to ninety-seven thousands per millimeter (about 0.001 to 0.097 mm⁻¹), across sixteen hundred (1600) simulated combinations. The synthetics data comprises of eight-hundred simulated sensor responses to varied aerosolized inks.

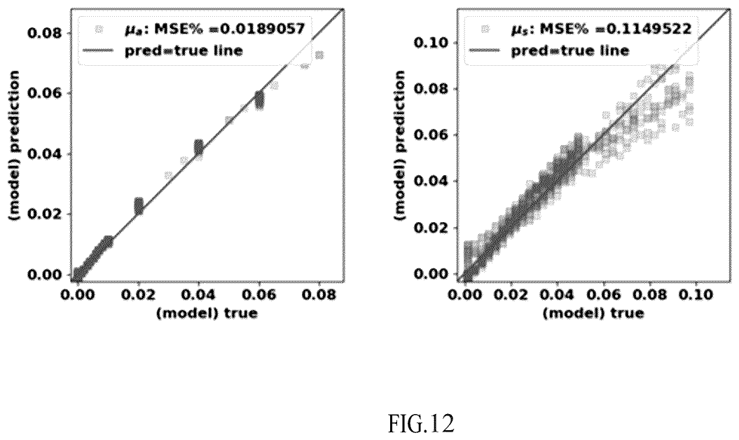

Using half of the synthetic dataset, linear regression models (e.g., 50% train-test split) were trained, to extracted absorption coefficient, μₐ, and scattering coefficient, μₛ, from the exemplary optical scattering sensor 104. FIG. 12 show the linear regression models prediction of absorption coefficients, μₐ, and scattering coefficients, μₛ, versus synthetic values. The results exhibit mean-squared-error (MSE) well below 0.5% for both absorption and scattering establishing the accuracy of the system.

In this disclosure, when functions, steps, etc. are “responsive to” or occur “in response to” another function or step, etc., the functions or steps necessarily occur as a result of another function or step, etc. A sensor or process that is responsive to another requires more than an action (i.e., the process and/or device's response to) merely follow another action.

In this disclosure the term “substantially” or “about” encompasses a range that is largely in some instances, but not necessarily wholly, that which is specified. It encompasses all but a significant amount, such as what is specified or within five to ten percent. In other words, the terms “substantially” or “about” means equal to or at or within five to ten percent of the expressed value. Forms of the term “cascade” and the term itself refer to an arrangement of two or more components such that the output of one component is the direct input of the next component (e.g., in a series connection). The term “unitary” refers to an indivisible entity, oneness, and singularity. It refers to a single indivisible entity or component.

The aerosol-jet printing system and optical scattering sensors individually that render the disclosed functions herein may be practiced in the absence of any disclosed or expressed element (including the components, hardware, the software, and/or the functionality expressed), and in the absence of some or all of the described functions association with a process step or component or structure that are expressly described. The systems may operate in the absence of one or more of these components, process steps, elements and/or any subset of the expressed functions. Further, the systems may function with additional or substitute elements and functionality, too. For example, there may be fewer or more photodiode detectors 702, optical channels, and more light sources of different wavelengths, λᵢ where i≥2.

Further, the various elements and system components, and process steps described in each of the many systems and processes described herein is regarded as divisible with regard to the individual elements described, rather than inseparable as a whole. In other words, alternate systems encompass any variation and combinations of elements, components, and process steps described herein and may be made, used, or executed without the various elements described (e.g., they may operate in the absence of) including some and all of those disclosed in the prior art but not expressed in the disclosure herein. Thus, some systems do not include those disclosed in the prior art including those not described herein and thus are described as not being part of those systems and/or components and thus rendering alternative systems that may be claimed as systems and/or methods excluding those elements and/or steps.

The disclosed optical scattering sensors 104 measure an aerosol using two or more silicon photodetectors 702 and two or more electromagnetic sources. The optical responses from those silicon photodetectors 702 are processed by a controller 818 to measure the optical scattering and/or absorption properties of the aerosol material being delivered to the target area.

In some systems, the composition of aerosolized materials, the aerosol's density, and the droplet size distributions, result in the measurement of variations in optical scattering and absorption rates within the visible (VIS) spectra and/or near-infrared (NIR) spectra. To discriminate between them, the optical scattering sensor 104 and monitoring system detect scattering at multiple scattering angles that form azimuthal angles relative to a flow path axis (e.g., a forward-scattering axis) and at multiple wavelengths, enabling the system to identify trends, and/or fit or compare measured scattering profiles to optical scattering and absorption properties through a data acquisition system (DAQ) 816 and controller 818. At the controller 818, relationships are identified and/or measurements are processed against models that may include machine learning models, linear regression models, etc., that detect and identify the optical scattering and/or absorption properties of the aerosolized particles. In some systems, the properties are mapped to known aerosol properties, including aerosol density, size distribution, and material composition, for example. In response, the controller 818 may initiate and/or execute corrective actions in real-time as deviations occur, predicted, or are detected or lie outside of a desired or predefined process window. The include initiating droplet size corrections (e.g., by modifying power to the atomizer), adjusting gas/aerosol pressure and/or flow rates, adjusting print/deposition head, adjusting the viscosity of the aerosolized media, and executing combinations of these corrections and/or executing other remediation actions.

Other systems, methods, features, and advantages will be, or will become, apparent to one with skill in the art upon examination of the figures and detailed description. It is intended that all such additional systems, methods, features, and advantages be included within this description, be within the scope of the disclosure, and be protected by the following claims.

1. A system for monitoring properties of an aerosolized-ink stream, comprising:
N detectors, where N≥3;
a light source configured to emit a light of different wavelengths A to which the detectors are sensitive, where i≥2;
a cell comprising a body comprising:
an inner cavity;
an inlet port and an outlet port arranged along a flow axis to allow the aerosolized-ink stream to pass through the inner cavity;
N channels extending radially from the inner cavity along respective polar angles θⱼ relative to the flow axis, where j≤N, wherein the detectors are optically coupled to the outer ends of the channels, respectively; and
an input aperture through which the light source is optically coupled to the inner cavity, the input aperture positioned on a forward-scattering axis that coincides with an axis of one of the N channels, such that axes of the remaining channels form respective azimuthal angles φₖ relative to the forward-scattering axis, where k≤(N−1);
a data acquisition module configured to acquire, concurrently from the N detectors, respective scattering signals, wherein each scattering signal is caused by a light of a particular wavelength λᵢ scattered along a respective angular direction by a plurality of droplets of the aerosolized-ink stream while it passes through the inner cavity;
a control module configured to:
apply a scattering model to map a plurality of properties of the aerosolized-ink stream to a plurality of values of the scattering signals; and
initiate corrective measures upon determining that the mapped properties are outside a process window.

2. The system of claim 1, wherein the polar angles comprise right angles, such that the N detectors are disposed within a plane orthogonal to the flow axis.

3. The system of claim 1, wherein the monitored properties of the aerosolized-ink stream comprise one or more of a composition, an aerosol density, or a droplet size distribution.

4. The system of claim 2 wherein the polar angles comprise right angles, such that the N detectors are disposed within a plane orthogonal to the flow axis.

5. The system of claim 4, wherein the light source comprises
a first LED configured to emit visible light, and
a second LED configured to emit near-IR light.

6. The system of claim 1, further comprising
a wavelength multiplexer optically coupled between the light source and the input aperture and configured to:
receive the light emitted by the light source, and
provide, through the input aperture into the inner cavity light having one wavelength at a time.

7. The system of claim 1, where the scattering model comprises an absorption coefficient, a scattering coefficient, and an anisotropy factor.

8. The system of claim 1 where the control module is configured to:
determine an absorption coefficient, a scattering coefficient, and an anisotropy factor based on corresponding values of scattering signals from the aerosolized-ink stream;
detect changes of the scattering model parameter values; and
correlate changes of a plurality of properties of the aerosolized-ink stream to the detected changes of the scattering model parameter values.

9. The system of claim 8, where the scattering model comprises a linear regression model.

10. The system of claim 8 where the control module is configured to correlate an upward shift in droplet size distribution to an increase of the scattering coefficient accompanied by a lower rate increase of the absorption coefficient.

11. The system of claim 10 where the control module is configured to correlate a decrease in a solvent content to a decrease the scattering coefficient accompanied by an increase in the absorption coefficient.

12. The system of claim 11 where the control module is configured to correlate an aerosol density without a change in a droplet size distribution to a proportional increase of the scattering coefficient and the absorption coefficient.

13. The system of claim 1, where the detectors comprise silicon-photodiode detectors.

14. The system of claim 13 wherein N comprises nine.

15. The system of claim 13, wherein the silicon-photodiode detectors are positioned about fifteen degree increments apart and are enclosed within a decagon shell.

16. The system of claim 15 wherein the silicon-photodiode detectors have an aperture diode of one and two millimeters.

17. An aerosolized-ink stream system, comprising:
a plurality of electroluminescent light sources;
an n-to-1 multiplexer that combines a plurality of n channels of electroluminescent light into a single optical channel;
a power splitting module that divides an optical signal delivered by the single optical channel between two optical fibers unevenly;
a reference detector optically coupled to the power splitting module that tracks the intensity of the optical signal by processing a smaller portion of the optical signal;
a collimator that narrows a larger portion of the optical signal and focuses a collimated light beam along an optical path;
an optical scattering sensor optically coupled to the optical path comprising:
an inner cavity;
an inlet port and an outlet port arranged along a flow axis to allow the aerosolized-ink stream to pass through the inner cavity;
N channels extending radially from the inner cavity along respective polar angles θⱼ relative to the flow axis, where j≤N, wherein the detectors are optically coupled to a plurality of outer ends of the channels, respectively; and
an input aperture through which the light source is optically coupled to the inner cavity, the input aperture positioned on a forward-scattering axis that coincides with an axis of one of the N channels, such that axes of the remaining channels form respective azimuthal angles φₖ relative to the forward-scattering axis, where k≤(N−1);
a transimpedance amplifier optically coupled to the reference detector and the optical scattering sensor that convert a first current generated by the reference detector and a second current generated by the optical scattering sensor into voltage signals, respectively;
a data acquisition module configured to acquire the voltage signals associated with the reference detector and the optical scattering sensor; and
a controller in communication with the data acquisition module that identifies a plurality of properties of the aerosolized-ink stream based on the voltage signals.

18. The system of any one of claim 17, where the controller identifies the plurality of properties of the aerosolized-ink stream through a scattering model that comprises a machine learning model.

19. An aerosol-jet printer comprising:
a transport stage configured to provide a stream of aerosolized-ink;
a deposition head configured to direct the aerosolized-ink stream to an object as the object is printed;
an optical scattering sensor optically coupled to the deposition head, comprising:
an inner cavity;
a plurality of detectors coupled to the inner cavity;
an inlet port and an outlet port arranged along a flow axis to allow the aerosolized-ink stream to pass through the inner cavity;
N channels extending radially from the inner cavity along respective polar angles relative to the flow axis, wherein the detectors are optically coupled to a plurality of outer ends of a plurality of channels; and
an input aperture through which a light source is optically coupled to the inner cavity, the input aperture positioned on a forward-scattering axis that coincides with an axis of one of the N channels, such that axes of the remaining channels form respective azimuthal angles relative to the forward-scattering axis.

20. The aerosol-jet printer of claim 19, further comprising a controller that processes output associated with the optical scattering sensor that is configured to transmit instructions to vary a carrier gas flow or an ink composition; wherein the transport stage comprises an ultrasonic atomizer.
